(19) United States
(12) Patent Application Publication
(10) Pub. No.: US 2026/0314519 A1
(43) Pub. Date: Oct. 15, 2026

(54) SYSTEM AND METHOD FOR GUIDING AN AGRICULTURAL VEHICLE ACROSS A FIELD WITH A USER INTERFACE ADAPTING TO DIFFERENT COMPENSATION MODES

(71) Applicant: Deere & Company, Moline, IL (US)

(72) Inventors: Akshay Kumar, Kaiserslautern (DE); Martin Seimetz, Heusweiler (DE); Paul Parage, Strasbourg (FR); Mariana Cristina Felix Garza, Dubuque, IA (US); Philipp Eike Feldmann, Hochspeyer (DE)

(21) Appl. No.: 19/572,233

(22) Filed: Mar. 19, 2026

Related U.S. Application Data
(60) Provisional application No. 63/787,085, filed on Apr. 11, 2025.

(51) Int. Cl. A01B 69/04; B60K 35/10; B60K 35/22; G06F 3/0482; G06F 3/0484; G06T 3/60; G06T 7/70

(52) U.S. Cl. CPC A01B 69/008; B60K 35/10; B60K 35/22; G06F 3/0482; G06F 3/0484; G06T 3/60; G06T 7/70; B60K 2360/11; B60K 2360/1438; B60K 2360/162; B60K 2360/176; G06T 2207/30252

(57) ABSTRACT

A position sensor provides a signal indicative of a sensed position of an agricultural vehicle. A user interface system receives a user input and provides a steering correction input based on the user input. A steering signal calculation unit identifies a steering mode corresponding to the vehicle and controls the user interface system to activate, as an activated correction input element, a first actuatable correction input element when the identified steering mode is a first steering mode and activate a second actuatable correction input element when the identified steering mode is a second steering mode. The steering signal calculation unit receives a target position for the vehicle and generates a steering signal, to control a steering actuator, based on a difference between the sensed position of the vehicle and the target position of the vehicle and based on the steering correction input received from the activated correction input element.

### FIELD OF THE DESCRIPTION

The invention relates to a system for guiding an agricultural vehicle over a field. More specifically, the present description relates to detecting a steering mode and controlling a user interface to make corrective steering inputs based on the detected steering mode.

### BACKGROUND

In agriculture, vehicles are autonomously steered across a field to make an operator's job easier and to allow him or her to focus on monitoring and controlling the work carried out when driving over the field, such as tillage, spreading chemicals or harvesting crops, or providing complete automation. In addition to state-of-the-art steering systems that generate a steering signal by means of a global navigation satellite system (GNSS) receiver and a (prestored or on-the-go-generated) map of the paths to be driven, sensor-based optical, ultrasonic and mechanical steering systems are known, which are based on an image signal from a camera or an active, scanning sensor (lidar or similar) or use ultrasonic sensors or mechanic feelers to recognize features in the field that are used to evaluate a path to be traveled. These features may be cultivation boundaries that entail a change in the soil profile, lanes, rows of plants, furrows, swaths and/or the edge of a crop that is still standing and to be harvested.

The sensors (and also the GNSS receivers) provide an input regarding the actual position and optionally direction of the vehicle with respect to a desired guideline for an open loop controller that controls the steering direction of the vehicle, generally by means of steering actuator controlling one or more steerable wheels or a speed differential of ground-engaging tracks or an articulation angle of the vehicle. In other words, the controller attempts to guide the vehicle such that the position of the vehicle as sensed by the sensor or GNSS receiver is located upon the desired guideline. For example, if the vehicle drives along rows of plants on a field, the controller will guide the vehicle to drive along the rows, with the tires passing between adjacent rows.

These automatic steering systems are normally not closed loop steering systems, since the real path driven by the vehicle, i.e., the offset between desired path and the driven path, is not sensed by the sensors. This can cause problems with misalignment between the desired path and the driven path for example if a reference angle of the sensor around the vertical axis (yaw angle) and/or lateral position of the sensor with respect to the vehicle does not correspond to a predefined angle, since then the orientation and/or position of features on the field is not correctly sensed and the steering signal is not correct, or the path of the vehicle is influenced by external forces, like gravitation, when driving on a lateral slope.

Thus, the prior art offers user interfaces for automatic steering systems allowing an operator of the vehicle to input or adjust for example a lateral offset between a guideline provided by a sensor and the guideline driven by the vehicle (Operator Manual Ultra Guidance PSR ISO by Reichhardt GmbH, Part No. 560143-0B, 2019) or to input a gain for correcting the influence of a sensed lateral slope onto the steering reaction (US 2008/0228353 A1). The operator thus provides correction inputs for the automatic steering system, which input by its nature depends on the respective sensor the automatic steering system is using.

In the prior art according to the Reichardt manual, the operator is enabled to select, on a main display screen menu of a touch-sensible display (virtual terminal according to ISO 11783), a sensor for automatic steering, like a mechanic or ultrasonic row sensor or steering based on GNSS, dependent on which sensors are provided on the vehicle. The correction inputs are performed by means of sub-menus. Thus, if a first type of sensor, like an ultrasonic sensor is selected in the main display screen menu, the correction input (lateral offset) is provided in the sub-menu for this sensor, and in a similar manner, a lateral offset can be input in a sub-menu if GNSS steering is selected.

### SUMMARY

Some sensors require different correction inputs depending on operating conditions of the agricultural vehicle. For example, if the vehicle is steered based on an optical row sensor, it is useful to input a lateral offset if the vehicle operates on flat land, but if the vehicle is operated on a lateral slope, a dependence between slope and steering signal might be useful to be inputted. This is not considered in the mentioned prior art, and thus an obvious solution would be to have one or two sub-menus for providing the different correction inputs. This makes the display confusing and complicated to operate.

The object underlying the invention is seen in providing a steering system for guiding an agricultural vehicle across a field and a corresponding method which do not suffer from the said disadvantages or have them to a lesser extent.

According to one example of the description, a position sensor provides a signal indicative of a sensed position of an agricultural vehicle. A user interface system receives a user input and provides a steering correction input based on the user input. A steering signal calculation unit identifies a steering mode corresponding to the vehicle and controls the user interface system to activate, as an activated correction input element, a first actuatable correction input element when the identified steering mode is a first steering mode and activate a second actuatable correction input element when the identified steering mode is a second steering mode. The steering signal calculation unit receives a target position for the vehicle and generates a steering signal, to control a steering actuator, based on a difference between the sensed position of the vehicle and the target position of the vehicle and based on the steering correction input received from the activated correction input element.

By way of example, only the appropriate correction input is enabled dependent on the steering operation mode and thus the disadvantages mentioned above are avoided or reduced.

In vision guidance systems, where the present proposal can be advantageously implemented, a perception sensor is mounted on the vehicle to detect field contours (such as row crops, windrows, tramlines etc.) and to guide the wheels precisely centred over the contour. In such systems, the steering control system can attain steady state with some remaining lateral offset still left uncorrected with respect to contour. This can happen due to two main reasons: (a) inaccurate mounting angle in yaw orientation with respect to a reference point on the machine, (b) inaccurate guidance in side-slopes. The steering control system can use automated methods to estimate the compensation needed in each of the scenarios mentioned above, but a final adjustment is offered to the operator on a user interface to compensate for (or to trim down) any remaining lateral errors.

The main reason behind this approach is that the final compensation can be achieved by correcting the yaw angle of the sensor data, which then corrects the detected contour perception points to not produce yawed output. And due to the same parameter being adjusted by different algorithms within the system, the operator is shown the right control input at the right terrain conditions to avoid confusion or erroneous input and enhance operator experience.

It is thus proposed to automatically display the right controls to the operator in different terrain conditions. Furthermore, the controls for the right sensor that is connected or selected are displayed. Also, the user interface can display an infographic icon to let the operator know that an algorithm is actively adjusting the compensation or indicated possible problems.

### BRIEF DESCRIPTION OF THE DRAWINGS

FIG. 1 is a lateral view of an agricultural vehicle with a system for automatic guidance of the vehicle over a field.

FIG. 2 is a top view of the vehicle when working in the field.

FIG. 3 is a schematic diagram of the arrangement for guiding the vehicle.

FIG. 4 is a display of a user interface during operation of the vehicle.

FIG. 5 to 7 and 9 to 11 show parts of the user interface in different operation modes.

FIG. 8 is a flow diagram for the steering operation based on visual row detection.

### DETAILED DESCRIPTION

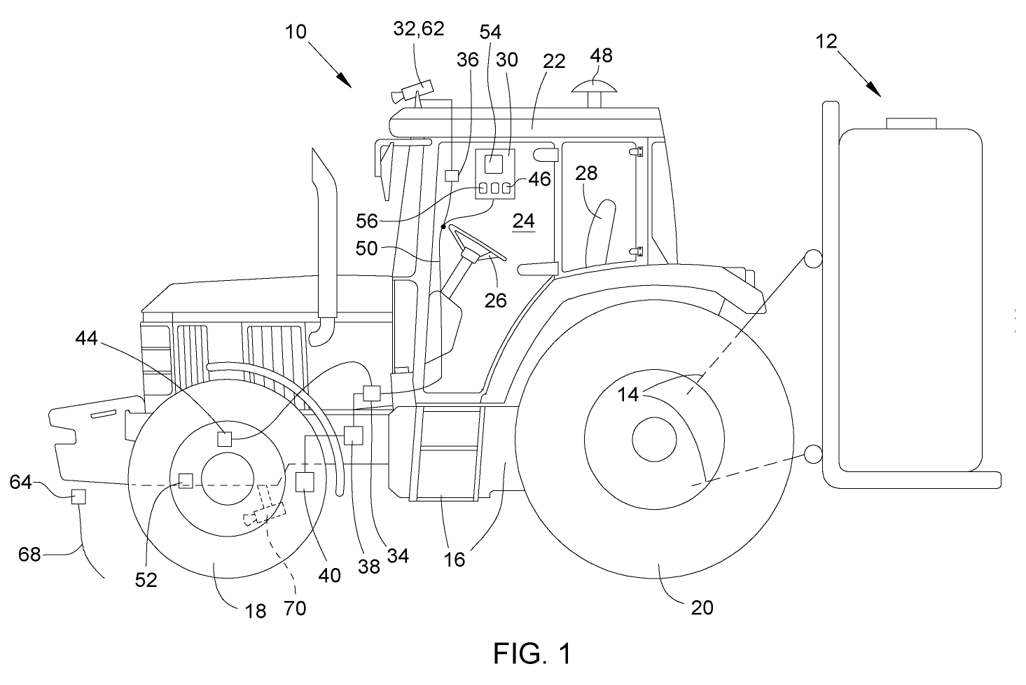

FIG. 1 shows a lateral view of a self-propelled agricultural vehicle 10 in the form of an agricultural tractor and a tool 12 in the form of a sprayer attached to a three-point linkage 14 of vehicle 10. Vehicle 10 is built on a supporting frame 16 supported on steerable front wheels 18 and driven rear wheels 20 and supports a cab 22 in which an operator's workstation 24 is located. The operator's workstation 24 includes a steering wheel 26, a seat 28, pedals (not shown) and a user interface 30. In the following, directions, such as front and rear or sideways, refer to the forward direction of vehicle 10, which is to the left in FIG. 1.

The vehicle 10 comprises an arrangement for the automatic guidance of the vehicle over a field comprising a visual sensor system 62 with a camera 32 designed as a mono or stereo camera (and/or a scanning, active sensor , e.g. a lidar system), an image processing system 36 connected to the image sensor of the camera 32 in a signal-transmitting manner, a navigation unit 48 mounted on the roof of cabin 22, a steering signal calculation unit 46 and a steering control system 34.

The navigation unit 48 is designed to receive signals from a satellite-based navigation system (GNSS, such as GPS, Galileo, etc.). The navigation unit 48 is equipped with an inertial measuring unit 66 to sense among others the inclination of the vehicle 10 in the lateral direction and in the forward direction and to improve the accuracy of the position signals, especially in unfavorable reception conditions. In addition, it may be connected to a receiver for receiving correction signals from an appropriate system (DGPS, RTK) to improve the precision of the navigation system signals and/or to odometric sensors detecting the direction of steering and movement of the front wheels 18, i.e., a steering angle sensor 44 and a speed sensor for detecting the rotation of the front wheels 18. The odometrically acquired signals are usually fused with those of the inertial navigation system and the satellite-based, possibly corrected signals, e.g., by a Kalman filter. The navigation unit 48 provides a signal at regular intervals with regard to its two- or three-dimensional position and orientation (at least lateral inclination) and optionally, its speed.

The vision system 36, the navigation unit 48, the steering signal calculation unit 46 and the steering control system 34 are connected to each other via a bus system 50, which can operate, for example, according to the protocol according to ISO 11783 or a successor thereto.

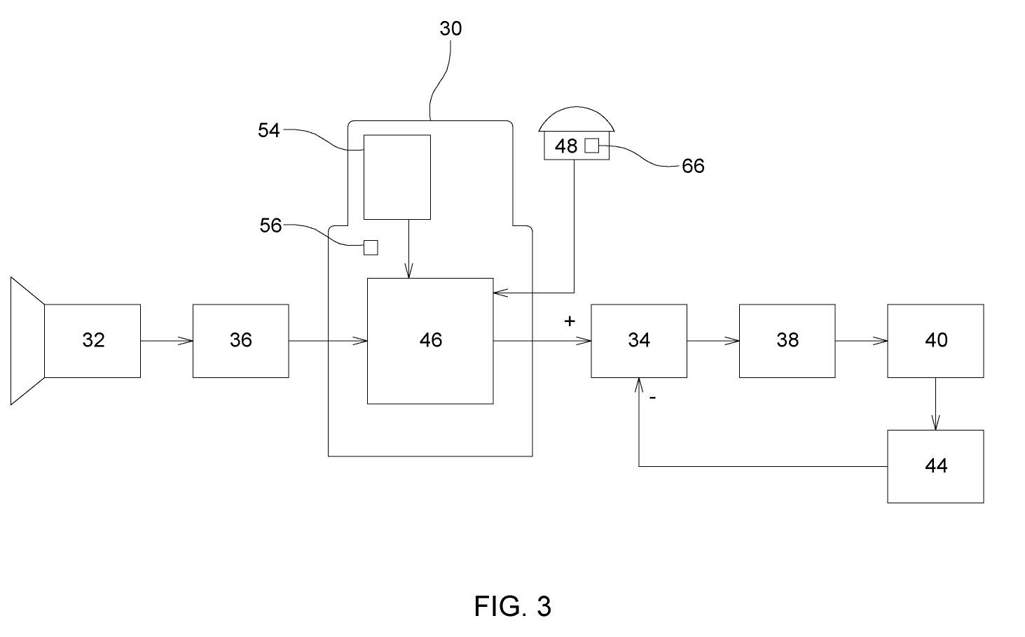

The steering signal calculation unit 46 is spatially integrated in a user interface 30, which is provided in the form of a display unit 54 with an input device 56, which can be formed by separate keys, as schematically indicated in FIG. 1 and 3 or be realized as touch-sensitive display unit 54. The user interface 30 can perform the function of a virtual display according to ISO 11783. It should be noted that the steering signal calculation unit 46 could also be physically separated from the user interface 30.

The steering control system 34 is connected to a valve unit 38 for controlling a steering actuator 40 and to the steering angle sensor 44 for detecting the current steering angle of the front wheels 18. These parts form an inner, closed control loop for controlling the steering direction of the vehicle 10.

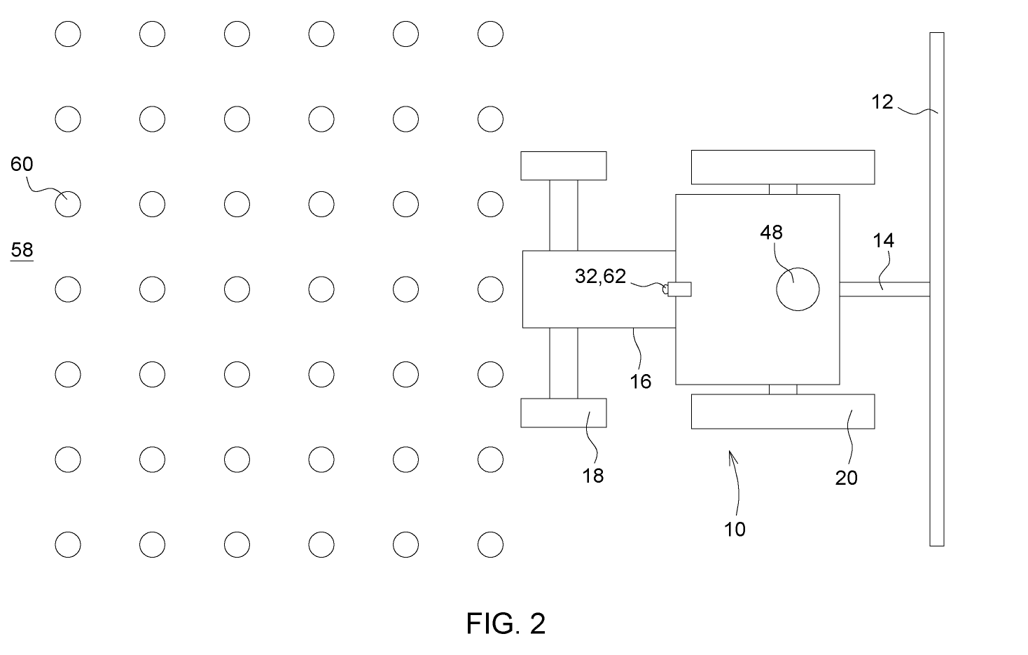

FIG. 2 shows a top view of vehicle 10 at work in a field 58 with plants 60 grown in rows. The steering control system 34 is controlled by the steering signal calculation unit 46 based on the signals of the visual sensor system 62 (camera 32) in a way that the front wheels 18 and the rear wheels 20 travel between the rows of plants 60 without passing over the plants 60. The visual sensor system 62 can detect plants 60 (cf. e.g., US 6 445 983 B1, EP 1 266 553 A2, WO 2008/150418 A1, WO 2018/067473 A1, Wan et al., loc. cit.), and/ or detect tramlines or lanes between plants 60, cf. DE 10 2016 209 437 A1. The tool 12 could also be any other type of tool, e.g., a hoe used to remove unwanted wild weeds between the rows of plants 60. In another embodiment, the implement could be a tillage implement, such as a plough or harrow, and the visual sensor system 62 could detect the boundary between untilled and tilled field 58. In yet another embodiment, vehicle 10 could be a harvester with a harvesting attachment or it moves a harvesting device, e.g., a mower, across the field and the visual sensor system 62 detects a standing edge of the crop that has not yet been harvested or a swath of crop to be collected by a pick-up. The vehicle 10 can also be provided with row sensors 64 with tactile feelers 68 or arranged as ultrasonic sensors to sense plants or furrows on the field.

The vehicle 10 has different sensors configured to provide a signal representing a sensed position or location and/or orientation and/or inclination of the vehicle (the location, the orientation, and/or the inclination of the vehicle 10 are collectively referred to as the position of the vehicle 10, so that the term position can mean the location of the vehicle 10 and/or the orientation of the vehicle 10 and/or the inclination of the vehicle 10), which are in the embodiment shown the visual sensor system 62 with camera 32 for detecting the position of the rows of plants 60 on the field 58, the row sensors 64 and the navigation unit 48 with the inertial measuring unit 66. The visual sensor system 62 senses the lateral position and orientation (around the vertical axis = yaw) of the vehicle 10 with respect to the rows of plants 60, allowing the steering signal calculation unit 46 to steer the vehicle 10 along the rows. The position and yaw of vehicle 10 is also sensed by the navigation unit 48, and the row sensors 64 are also sensing the lateral position of the vehicle 10 with respect to features on the field 58, like rows or furrows. As known in the art, these lateral position signals and optionally yaw signals can be used, either alone or in combination, for automatically steering the vehicle 10. The lateral inclination (roll angle) sensed by the inertial measuring unit 66 (or a separate sensor or by means of a second navigation unit, laterally offset from the shown navigation unit 48) can be used to provide a correction input to the steering signal in particular when working on lateral slopes (cf. US US 2008/0228353 A1, incorporated herein by reference).

Generally, the operator will be able to select which of the sensors (in particular, row sensors 64, camera 32 or navigation unit 48) are used for automatic steering, although this selection could be performed automatically for example dependent on the (quality of the) outputs of the respective sensors, and switches automatic steering on an off, using the input device 56 of the user interface 30.

The visual sensor system 62, such as the (stereo) camera 32, is usually mounted on a hardware bracket which can be subjected to tolerance stack-up leading to minor offsets on the different degrees of freedom (DoFs) with respect to a reference point on the machine. The stack-up of tolerance can be due to manufacturing inaccuracies, mounting differences, etc. A calibration procedure can be performed to estimate some of the DoFs, but small inaccuracies in the calibration of the camera’s yaw angle can lead to significant lateral offsets of the vehicle 10 to the mid of the contour to be driven along. The operator can enter offset corrections in cm or other units which (based on known dimensions – especially the cam look-ahead distance) is converted into a yaw adjust angle which is applied in the contour detection algorithm. As described later, this input is offered to the operator only in flat terrain.

On the other hand, driving along side-slope hills can make the machine “crab” (yaw turning even though the machine is driving straight). This drifting machine movement has a similar effect on the perception points as a wrong dynamic calibration above and needs to be compensated by a yaw adjust angle. While this angle could be measured with a dual-antenna setup, it is estimated herein based on the measured roll-angle of the terrain (which can be measured accurately by the inertial measurement unit 66). However, the accuracy of this yaw estimation is affected by several unmeasurable factors like soil conditions. Thus, the operator is given the opportunity to adjust the aggressiveness of this side slope compensation to make the machine to drive more uphill or downhill, as also described below.

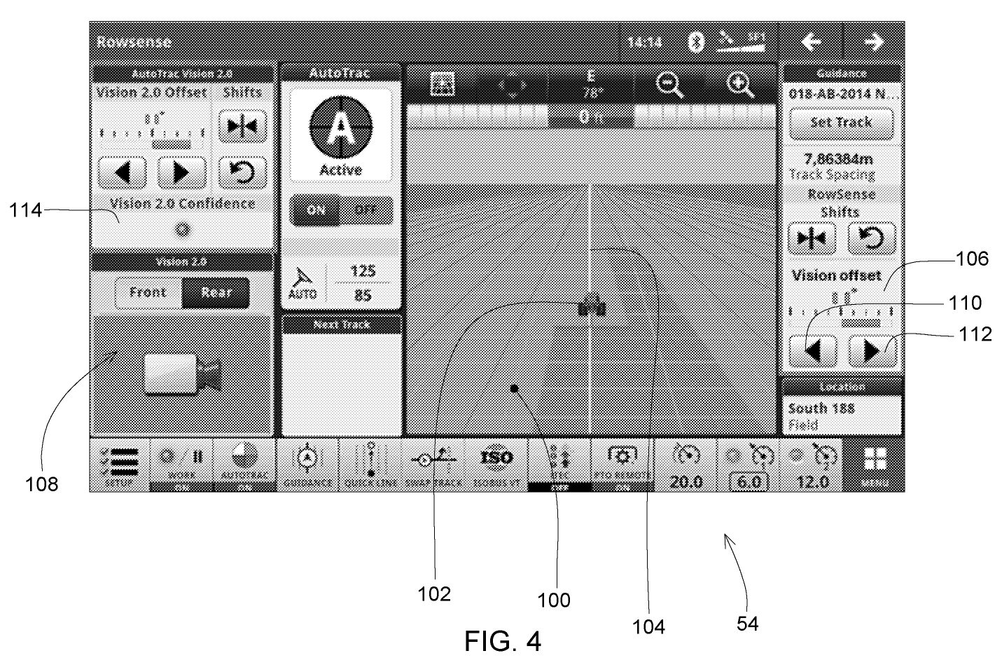

FIG. 4 shows the display unit 54 of user interface 30 during operation when steering signal calculation unit 46 controls steering control system 34 to steer the vehicle 10 over the field 58. Among others, in an area 100 a perspective image of the field 58 is shown, indicating the vehicle 10 on its path 104 represented by an icon 102. An area 108 at the left side indicates that camera 32 is used for steering. Another area 106 at the right side indicates a correction input by virtual keys 110, 112 enabling the operator to move the vehicle 10 to the left or to the right with respect to the path provided by the steering signal calculation unit 46. This correction input can be useful in particular in case that camera 32 is rotated around the yaw axis with respect to a calibrated or predetermined position. The virtual keys 110, 112 and the inputted offset are also shown in an area 114 on the left side of the display unit 54 above area 108.

Another correction input is shown in FIG. 6, allowing the operator to input the sensitivity of a steering correction for camera-based steering on lateral slope. Now, the virtual keys 110, 112 are not used for inputting an offset, but define the steering reaction of steering signal calculation unit 46 to a lateral slope, as described in more detail in US 2008/0228353 A1.

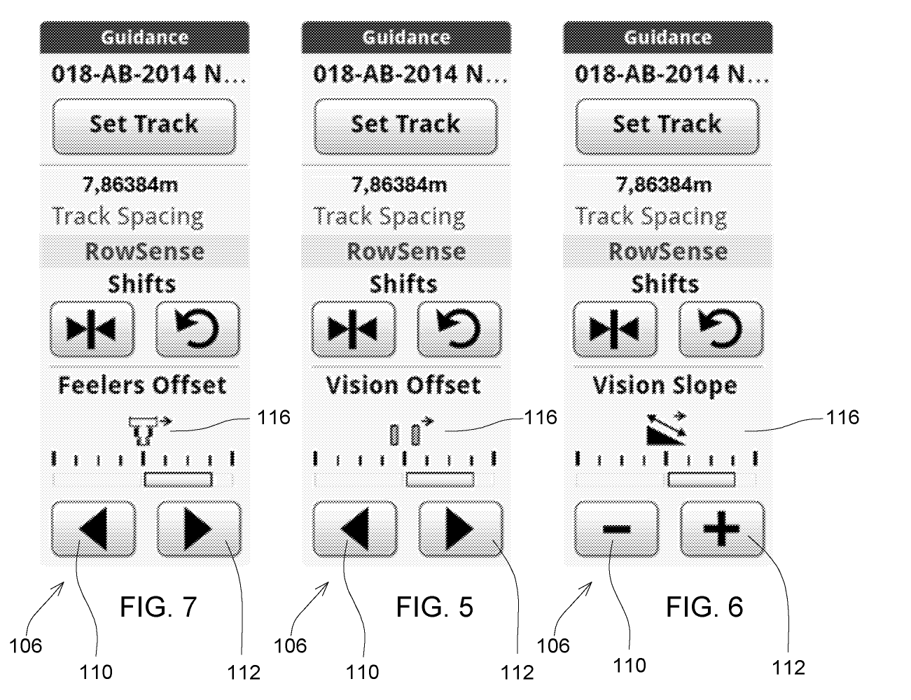

If a steering is performed based on the row sensors 64, the display unit 54 will show generally the same image as in FIG. 4, but the area 106 of FIG. 4, which is also shown separately in FIG. 5, will be replaced with the area 106 as shown in FIG. 7.

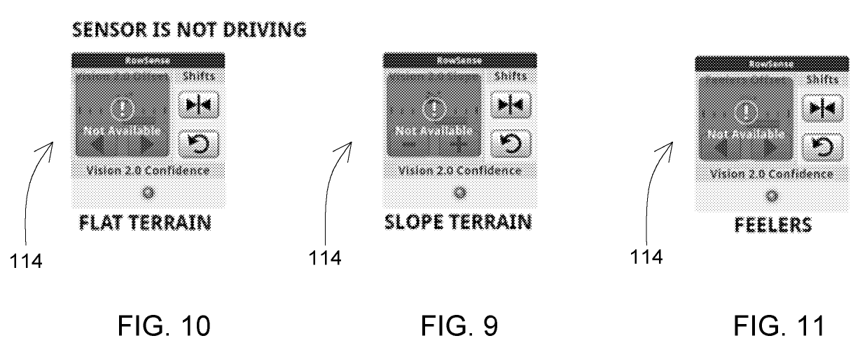

If a sensor is selected for steering, but the steering signal calculation unit 46 determines that the respective sensor is not operating correctly, the virtual keys 110, 112 and the inputted offset are greyed out in area 114, as shown in FIG. 9 to 11 (corresponding to FIG. 6, 5 and 7), what is preferably also the case in area 106. In this case, automatic steering based on the particular sensor is disabled and the operator needs to steer the vehicle 10 manually or revert to automatic steering based on another sensor.

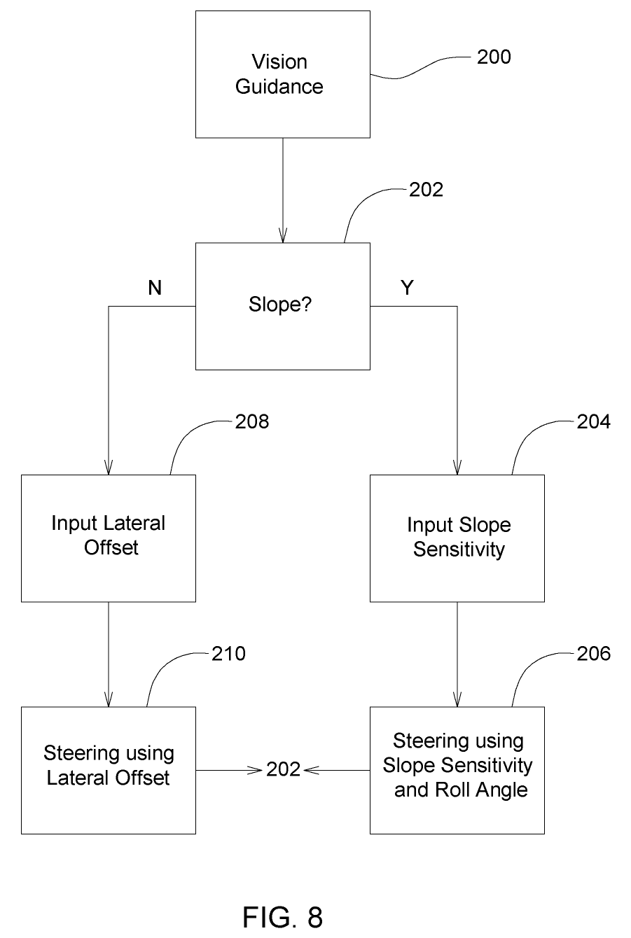

Reference is now made to FIG. 8, showing a flow diagram indicating operation of the steering signal calculation unit 46 according to a first steering mode (such as when vehicle 10 is operating on a side slope or lateral slope, e.g., a slope that meets a threshold slope value) or a second steering mode (such as when vehicle 10 is operating on relatively flat terrain, e.g., terrain that does not meet the threshold slope value) when automatically steering vehicle 10 based on the visual sensor system 62. After start in step 200, in step 202 the lateral slope on which vehicle 10 operates (roll angle of the vehicle 10) is detected, based on the sensors described above. If the lateral slope is above a certain threshold, at which a noticeable deviation of the vehicle’s path from an expected path due to a lateral slope can be expected, since the gravitational forces attempt to pull vehicle 10 down the slope, what cannot be corrected by steering signal calculation unit 46 based on the signal from camera 32 alone, step 204 follows, enabling the operator to input the sensitivity of vehicle 10 to the lateral slope. In step 204, the area 106 of FIG. 6 is displayed to the operator on the display unit 54 of user interface 30, allowing to input the lateral sensitivity with keys 110, 112 and displaying the inputted sensitivity in an icon 116. In step 206, this inputted lateral sensitivity is used by the signal calculation unit 46 to provide the steering signal to the inner control loop for controlling the steering direction of the vehicle 10.

On the other hand, if step 202 reveals that no significant lateral slope is present, step 208 follows, in which the operator is enabled to input a lateral offset of the vehicle 10 with respect to the path provided by the steering signal calculation unit 46, by means of the virtual keys 110, 112 on area 106 on the display unit of user interface 30 as indicated in FIG. 4 and 5, showing the inputted offset in an icon 116. In step 210, this inputted offset is used by the steering signal calculation unit 46 to provide the steering signal to the inner control loop for controlling the steering direction of the vehicle 10.

After steps 206 and 210, step 202 is executed again. In order to avoid a frequent, disturbing switching between both operating modes of FIG. 8 when the lateral inclination is around 0°, a suitable threshold can be used before the steering signal calculation unit 46 switches between the left and right branch of FIG. 8.

It should be noted that, while FIG. 6 indicates that the slope compensation, indicated by icon 116 and inputted by keys 110, 112 is a distance (like the lateral deviation of the vehicle 10 from the desired path after driving a certain distance), it can also be represented as an angle, i.e., the angle of the vehicle 10 with respect to the desired path without compensation. Hence, under side hill conditions as represented by the right branch of FIG. 8, the slope compensation angle could be added to the vision sensor offset based value from the flat terrain to one (single) yaw adjust angle. This angle should be applied very early in the camera signal flow to avoid any inconsistencies. The application could be realized with turning a map representing detected features on the field 58, in particular, the plants 60 or rows of plants in the image provided by the camera 32 with this angle. In other words, the camera image or data derived therefrom is or are turned by the yaw angle around the vertical axis to correct the expected misorientation of the vehicle 10 on the lateral slope and the misorientation of the camera 32 by proactively correcting the perspective of the camera 32 to avoid this problem. In this context, reference is made to DE 10 2019 203 648 A1 and the prior art references cited therein.

In further developments, it is possible to use an additional sensor 70 (mono camera underneath the chassis of the machine, cf. DE 10 2023 119 302 A1 and FIG. 1) to detect vehicle offsets from a desired path and compensate the steering angle automatically, while disabling the usage of the buttons 110, 112. In these scenarios, these buttons in affected areas 106 and 114 should turn disabled and grey, as shown in FIG. 9, and a new infographic icon can be displayed to clearly indicate to the operator that an algorithm is actively adjusting the required compensation.

The display unit 54 of user interface 30 automatically displays the correct sensor controls depending on the sensor that is actively driving, as mentioned. For example, if row sensors 64 are available on the vehicle 10 for guidance and are actively control steering the vehicle 10, the image as shown in FIG. 7 is included into the display of FIG. 4 at area 106. If a guidance line fall-back is guiding the vehicle 10, then those controls will be shown on the guidance settings module in area 106 and the area 114 for the row sensor guidance will be greyed out as shown in FIG. 11.

### Steps of FIG. 8

200 Vision Guidance

202 Slope?

204 Input Slope Sensitivity

206 Steering using Slope Sensitivity and Roll Angle

208 Input Lateral Offset

210 Steering using Lateral Offset

What is claimed is:

1. A computer implemented method for guiding an agricultural vehicle over a field, comprising:
sensing a position of the agricultural vehicle;
sensing a steering mode corresponding to the agricultural vehicle;
activating, as an activated correction user input element on a user interface system, a first actuatable user input element when the sensed steering mode is a first steering mode and activating a second actuatable user input element when the sensed steering mode is a second steering mode;
receiving a steering correction input from the activated correction user input element; and
generating a steering signal, to control a steering actuator, based on a difference between the sensed position of the agricultural vehicle, the target position of the agricultural vehicle, and the steering correction input received from the activated correction user input element.

2. The computer implemented method of claim 1 and further comprising:
automatically switch between activating the first actuatable user input element and the second actuatable user input element when the sensed steering mode switches between the first steering mode and the second steering mode.

3. The computer implemented method of claim 2 wherein sensing the position of the agricultural vehicle comprises:
capturing an image with a visual sensor system; and
identifying the position of the agricultural vehicle based on the image.

4. The computer implemented method of claim 3 wherein sensing a steering mode comprises:
detecting whether the agricultural vehicle is operating on a lateral slope, and if not, then activating the first actuatable user input element comprises activating, as the activated correction user input element, a lateral offset user input element that, when actuated by a user, receives a lateral offset steering correction indicative of a corrective lateral offset from a nominal path.

5. The computer implemented method of claim 4 wherein, if the agricultural vehicle is not operating on a lateral slope, then activating the first actuatable user input element comprises:
activating, as the activated correction user input element, a lateral slope offset user input element that, when actuated by a user, receives a lateral slope offset steering correction indicative of a corrective steering response to a sensed lateral slope.

6. The computer implemented method of claim 5 wherein detecting whether the agricultural vehicle is operating on a lateral slope comprises:
detecting a lateral slope angle on which the agricultural vehicle is operating;
comparing the lateral slope angle to a threshold slope angle to obtain a comparison result; and
detecting whether the agricultural vehicle is operating on a lateral slope based on the comparison result.

7. The computer implemented method of claim 1 wherein activating a first actuatable user input element when the identified steering mode is a first steering mode and activating a second actuatable user input element when the identified steering mode is a second steering mode comprises:
controlling the user interface system to display a first actuatable element on a display unit enabling user input of a first correction input when the sensed steering mode is the first steering mode and to display a second actuatable element on the display unit enabling user input of a second correction input when the sensed steering mode is the second steering mode.

8. The computer implemented method of claim 7 and further comprising:
controlling the user interface system to display the first correction input by the user based on actuation of the first actuatable element and to display the second correction input by the user based on actuation of the second actuatable element.

9. The computer implemented method of claim and further comprising:
detecting whether an automated steering correction is generated; and
if so, deactivating the first actuatable user input element and the second actuatable user input element.

10. The computer implemented method of claim 3 and further comprising:
rotating the image captured by the visual sensor system and wherein identifying the position of the agricultural vehicle comprises identifying the position of the agricultural vehicle based on the rotated image.

11. A system for guiding an agricultural vehicle over a field, comprising:
a position sensor configured to provide a signal indicative of a sensed position of the vehicle;
a user interface system configured to receive a user input and provide a steering correction input based on the user input; and
a steering signal calculation unit configured to identify a steering mode corresponding to the vehicle and control the user interface system to activate, as an activated correction input element, a first actuatable correction input element when the identified steering mode is a first steering mode and activate a second actuatable correction input element when the identified steering mode is a second steering mode, the steering signal calculation unit being further configured to receive a target position for the vehicle and generate a steering signal, to control a steering actuator, based on a difference between the sensed position of the vehicle and the target position of the vehicle and based on the steering correction input received from the activated correction input element.

12. The system of claim 11 wherein the steering calculation unit is configured to automatically switch between activating the first actuatable user input element and the second actuatable user input element when the sensed steering mode switches between the first steering mode and the second steering mode.

13. The system of claim 12 the position sensor comprises:
an image capture device configured to capture an image; and
an image processing system configured to identify the position of the agricultural vehicle based on the image.

14. The system of claim 13 wherein sensing a steering mode comprises:
a lateral slope sensor configured to detecting, and generate an output indicative of, whether the agricultural vehicle is operating on a lateral slope and, if not, the steering signal calculation unit being configured to activate, as the activated correction user input element, a lateral offset user input element that, when actuated by a user, receives a lateral offset steering correction indicative of a corrective lateral offset from a nominal path.

15. The system of claim 14 wherein, if the lateral slope sensor detects that the agricultural vehicle is not operating on a lateral slope, then the steering signal calculation unit is configured to activate, as the activated correction user input element, a lateral slope offset user input element that, when actuated by a user, receives a lateral slope offset steering correction indicative of a corrective steering response to a sensed lateral slope.

16. The system of claim 15 wherein the lateral slope sensor is configured to detect a lateral slope angle on which the agricultural vehicle is operating and wherein the steering calculation unit is configured to compare the lateral slope angle to a threshold slope angle to obtain a comparison result and detect whether the agricultural vehicle is operating on a lateral slope based on the comparison result.

17. The system of claim 11 wherein the steering signal calculation unit is configured to control the user interface system to display a first actuatable element on a display unit enabling user input of a first correction input when the sensed steering mode is the first steering mode and to display a second actuatable element on the display unit enabling user input of a second correction input when the sensed steering mode is the second steering mode.

18. The system of claim 17 wherein the steering signal calculation unit is configured to control the user interface system to display the first correction input by the user based on actuation of the first actuatable element and to display the second correction input by the user based on actuation of the second actuatable element.

19. The system of claim 13 wherein the steering signal calculation unit is configured to rotate the image captured by the image capture device and wherein identifying the position of the agricultural vehicle comprises identifying the position of the agricultural vehicle based on the rotated image.

20. A computer implemented method, comprising:
sensing a position of an agricultural vehicle;
sensing a steering mode corresponding to the agricultural vehicle;
activating one of a plurality of different correction user input elements based on the sensed steering mode;
receiving a steering correction input from the activated correction user input element; and
generating a steering signal, to control a steering actuator, based on the sensed position of the agricultural vehicle and the steering correction input received from the activated correction user input element.
